(19) United States
(12) Patent Application Publication
(10) Pub. No.: US 2005/0192394 A1
(43) Pub. Date: Sep. 1, 2005

(54) UV-crosslinkable laminating adhesives

(75) Inventors: Martin Jung, Mannheim (DE); Christelle Staller, Seltz (FR); Hans-Joachim Fricke, Dirmstein (DE); Alexander Centner, Neustadt (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/701,590

(22) Filed: Nov. 6, 2003

(30) Foreign Application Priority Data
Nov. 14, 2002 (DE) 102 53 332.6

(51) Int. Cl. C08F 2/16; C08K 3/20

(52) U.S. Cl. 524/458

(57) ABSTRACT

The use of compositions comprising a copolymer obtainable by multistage free-radical polymerization, in which first an aqueous polymer dispersion is prepared (referred to for short as 1st stage) and in at least one further stage monomers are polymerized in the presence of the resulting polymer dispersion (all further stages referred to for short as 2nd stage).

The invention relates to the use of compositions comprising a copolymer obtainable by multistage free-radical polymerization, in which first an aqueous polymer dispersion is prepared (referred to for short as 1st stage) and in at least one further stage monomers are polymerized in the presence of the resulting polymer dispersion (all further stages referred to for short as 2nd stage), as laminating adhesive.

The invention further relates to the use of the composition as an adhesive for high gloss film lamination.

For laminations, adhesives based on crosslinkable polymers are generally used.

In high gloss film lamination, normally first a transparent polymer film, generally oriented polypropylene OPP or else polyacetate, is coated with the liquid adhesive. Then the adhesive is dried and the coated film is then laminated, using pressure and heat, to the printed material, generally a printed card or paper. The resultant laminate is frequently grooved or embossed during further processing. For stability during grooving or embossing the adhesive layer must withstand these deformations of the laminate, and in the groove or at the embossed points there must be no separation of the gloss film from the printed material. To ensure this, chemically crosslinked adhesive systems are generally used.

Chemically crosslinking polymer dispersions for high gloss film lamination are known, for example, from EP-A-148386 or EP-A-644902.

Also known are polymers obtainable by multistage emulsion polymerization.

WO 98/10001 describes a process which can be referred to as a swelling polymerization. There, monomers are first prepared in conventional manner by emulsion polymerization using free-radical initiators and thereafter further monomers are added without the use of additional initiator.

It is an object of the present invention to provide adhesives which are highly suitable for high gloss film lamination and which comply outstandingly with the requirements in terms in particular of adhesion, grooving stability and embossing stability. As far as possible these requirements should be met with only small amounts of crosslinker.

We have found that this object is achieved by the use defined at the outset.

The copolymer used in accordance with the invention is in particular a copolymer obtainable by free-radical polymerization, in particular by emulsion polymerization.

Preferably at least 40% by weight of the copolymer, particularly preferably at least 60% by weight, very particularly preferably at least 80% by weight, is composed of principal monomers.

The principal monomers are selected from C₁-C₂₀ alkyl (meth)acrylates, vinyl esters of carboxylic acids containing up to 20 carbon atoms, vinylaromatics having up to 20 carbon atoms, ethylenically unsaturated nitriles, vinyl halides, vinyl ethers of alcohols containing from 1 to 10 carbon atoms, aliphatic hydrocarbons having from 2 to 8 carbon atoms and 1 or 2 double bonds, and mixtures of these monomers.

Mention may be made, for example, of alkyl (meth)acrylates having a C₁-C₁₀ alkyl radical, such as methyl methacrylate, methyl acrylate, n-butyl acrylate, ethyl acrylate, and 2-ethylhexyl acrylate.

Mixtures of the alkyl (meth)acrylates are also particularly suitable.

Examples of vinyl esters of carboxylic acids having from 1 to 20 carbon atoms are vinyl laurate, vinyl stearate, vinyl propionate, Versatic acid vinyl esters, and vinyl acetate.

Possible vinylaromatic compounds are vinyltoluene, α- and p-methylstyrene, α-butylstyrene, 4-n-butylstyrene, 4-n-decylstyrene, and, preferably, styrene. Examples of nitriles are acrylonitrile and methacrylonitrile.

The vinyl halides are chlorine-, fluorine- or bromine-substituted ethylenically unsaturated compounds, preferably vinyl chloride and vinylidene chloride.

Examples of vinyl ethers which may be mentioned are vinyl methyl ether and vinyl isobutyl ether. Preference is given to vinyl ethers of alcohols containing from 1 to 4 carbon atoms.

As hydrocarbons having from 2 to 8 carbon atoms and two olefinic double bonds, mention may be made of butadiene, isoprene and chloroprene.

Preferred principal monomers are the C₁-C₁₀ alkyl acrylates and C₁-C₁₀ alkyl methacrylates, in particular C₁-C₈ alkyl acrylates and C₁-C₈ alkyl methacrylates, and in each case the acrylates are particularly preferred.

Very particular preference is given to methyl acrylate, ethyl acrylate, n-butyl acrylate, n-hexyl acrylate, octyl acrylate and 2-ethylhexyl acrylate, and also to mixtures of these monomers.

The copolymer is preferably a chemically crosslinkable copolymer.

Crosslinking may take place, for example, through photochemical activation. For that purpose the copolymer may contain photoinitiator groups, as a result, for example, of copolymerization with corresponding monomers containing photoactivable groups. Photoinitiators can also be added separately.

The copolymer preferably contains functional groups which are able to undergo a chemical crosslinking reaction with an added crosslinker.

The amount of such functional groups or else of photoactivable groups or else of photoinitiators is in particular from 0.0001 mol to 1 mol, more preferably from 0.0002 to 0.1 mol, and very preferably from 0.0006 to 0.03 mol per 100 g of copolymer.

The chemical crosslinking reaction is in particular a reaction which occurs or is initiated (e.g., with high-energy light) not until during or after the subsequent filming of the copolymer, i.e., during or after the volatilization of the water of the dispersion, and not as soon as a crosslinker has been added to the aqueous dispersion of the copolymer.

The functional groups are preferably keto or aldehyde groups. The keto or aldehyde groups are preferably attached to the polymer by copolymerization of copolymerizable, ethylenically unsaturated compounds containing keto or aldehyde groups. Suitable compounds of this kind include acrolein, methacrolein, vinyl alkyl ketones having from 1 to 20, preferably from 1 to 10, carbon atoms in the alkyl radical, formyl styrene, alkyl (meth)acrylates having one or two keto or aldehyde groups or one keto group and one aldehyde group in the alkyl radical, the alkyl radical preferably containing a total of from 3 to 10 carbon atoms, e.g., (meth)acryloyloxyalkylpropanals, such as are described in DE-A-2722097. Also suitable, furthermore, are N-oxoalkyl(meth)acrylamides such as are known, for example, from U.S. Pat. No. 4,226,007, DE-A-2061213 or DE-A-2207209.

Particular preference is given to acetoacetyl (meth)acrylate, acetoacetoxyethyl (meth)acrylate, and, in particular, diacetoneacrylamide.

Besides the principal monomers and monomers able to react with a crosslinker, the copolymer may contain other monomers, e.g., monomers with carboxylic acid, sulfonic acid or phosphonic acid groups. Carboxylic acid groups are preferred. Examples which may be mentioned are acrylic acid, methacrylic acid, itaconic acid, maleic acid, and fumaric acid.

Examples of other monomers include monomers containing hydroxyl groups, in particular C₁-C₁₀ hydroxyalkyl (meth)acrylates, and (meth)acrylamide.

Other monomers which may additionally be mentioned are phenyloxyethyl glycol mono(meth)acrylate, glycidyl acrylate, glycidyl methacrylate, and amino (meth)acrylates, such as 2-aminoethyl (meth)acrylate.

Monomers which carry other functional groups in addition to the double bond, e.g., isocyanate groups, amino groups, hydroxyl groups, amide groups or glycidyl groups, may, for example, improve the adhesion to substrates.

The glass transition temperature of the copolymer is preferably below 60° C., in particular from −50 to +60° C., particularly preferably from −30 to +40° C., and very particularly preferably from −30 to +20° C.

The glass transition temperature of the copolymer may be determined by conventional methods, such as differential thermal analysis or differential scanning calorimetry (see, for example, ASTM 3418/82, midpoint temperature).

The copolymer is preferably prepared by emulsion polymerization and is therefore an emulsion polymer.

Surface-active compounds used in the emulsion polymerization are ionic and/or nonionic emulsifiers and/or protective colloids or, respectively, stabilizers.

A detailed description of suitable protective colloids is found in Houben-Weyl, Methoden der organischen Chemie, Vol. XIV/1, Makromolekulare Stoffe, Georg-Thieme-Verlag, Stuttgart, 1961, pp. 411-420. Emulsifiers which may be used are either anionic, cationic or else nonionic emulsifiers. Preferably, the auxiliary surface-active substances used are exclusively emulsifiers, whose molar mass is usually below 2 000 g/mol, unlike that of the protective colloids. Preference is given to the use of anionic and nonionic emulsifiers as surface-active substances. Examples of commonly used auxiliary emulsifiers are ethoxylated fatty alcohols (EO units: from 3 to 50, alkyl: C₈-C₃₆), ethoxylated mono-, di- and trialkylphenols (EO units: from 3 to 50, alkyl: C₄-C₉), alkali metal salts of dialkyl esters of sulfosuccinic acid, and also the alkali metal and ammonium salts of alkyl sulfates (alkyl: C₈-C₁₂), of ethoxylated alkanols (EO units: from 4 to 30, alkyl: C₁₂-C₁₈), of ethoxylated alkylphenols (EO units: from 3 to 50, alkyl: C₄-C₉), of alkylsulfonic acids (alkyl: C₁₂-C₁₈), and of alkylarylsulfonic acids (alkyl: C₉-C₁₈).

Other suitable emulsifiers are compounds of the formula II 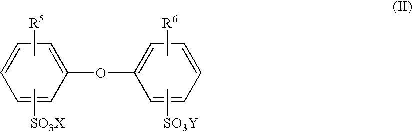
where R⁵ and R⁶ are hydrogen or C₄-C₁₄ alkyl but are not simultaneously hydrogen, and C and Y may be alkali metal ions and/or ammonium ions. R⁵ and R⁶ are preferably linear or branched alkyl having from 6 to 18 carbon atoms or hydrogen and in particular having 6, 12 or 16 carbon atoms, R⁵ and R⁶ not both being simultaneously hydrogen. X and Y are preferably sodium, potassium or ammonium ions, sodium being particularly preferred. Particularly advantageous compounds II are those in which X and Y are sodium, R⁵ is branched alkyl having 12 carbon atoms and R⁶ is hydrogen or R⁵. Use is frequently made of industrial mixtures which have a proportion of from 50 to 90% by weight of the monoalkylated product, for example Dowfax® 2A1 (trademark of Dow Chemical Company).

Examples of tradenames of emulsifiers are Dowfax® 2 A1, Emulan® NP 50, Dextrol® OC 50, Emulgator 825, Emulgator 825 S, Emulan® OG, Texapon® NSO, Nekanil® 904 S, Lumiten® I-RA, Lumiten E 3065, Disponil FES 77, Lutensol AT 18, Steinapol VSL, and Emulphor NPS 25.

The surface-active substance is usually used in amounts of from 0.1 to 10% by weight, based on the monomers to be polymerized.

Examples of water-soluble initiators for the emulsion polymerization are ammonium salts and alkali metal salts of peroxodisulfuric acid, e.g., sodium peroxodisulfate, and hydrogen peroxide and organic peroxides, such as tert-butyl hydroperoxide.

Reduction-oxidation (redox) initiator systems are particularly suitable.

Redox initiator systems are composed of at least one, usually inorganic, reducing agent and an inorganic or organic oxidant.

The oxidation component is, for example, one of the initiators already mentioned above for the emulsion polymerization.

The reducing components are, for example, alkali metal salts of sulfurous acid, such as sodium sulfite and sodium hydrogensulfite, alkali metal salts of disulfurous acid, such as sodium disulfite, bisulfite addition compounds of aliphatic aldehydes and ketones, such as acetone bisulfite, or reducing agents such as hydroxymethanesulfinic acid and its salts, or ascorbic acid. The redox initiator systems may be used accompanied by soluble metal compounds whose metallic component can occur in more than one valence state.

Examples of usual redox initiator systems are ascorbic acid/iron(II) sulfate/sodium peroxodisulfate, tert-butyl hydroperoxide/sodium disulfite and tert-butyl hydroperoxide/Na hydroxymethanesulfinate. The individual components, e.g., the reducing component, may also be mixtures, e.g., a mixture of the sodium salt of hydroxymethanesulfinic acid and sodium disulfite.

The compounds mentioned are usually used in the form of aqueous solutions, the lower concentration being determined by the amount of water acceptable in the dispersion and the upper concentration by the solubility in water of the particular compound. The concentration is generally from 0.1 to 30% by weight, preferably from 0.5 to 20% by weight, particularly preferably from 1.0 to 10% by weight, based on the solution.

The amount of the initiators is generally from 0.1 to 10% by weight, preferably from 0.5 to 5% by weight, based on the monomers to be polymerized. It is also possible to use more than one different initiator in the emulsion polymerization.

Regulators may be used in the polymerization, for example in amounts of from 0 to 0.8 part by weight, based on 100 parts by weight of the monomers to be polymerized, and these reduce the molecular weight. Examples of suitable compounds are those with a thiol group, such as tert-butyl mercaptan, ethylhexyl thioglycolate, mercaptoethanol, mercaptopropyltrimethoxysilane and tert-dodecyl mercaptan. The proportion of these regulators can be in particular from 0.05 to 0.8 part by weight, preferably from 0.1 to 0.5 part by weight, based on 100 parts by weight of the monomers to be polymerized.

The emulsion polymerization generally takes place at from 30 to 130° C., preferably from 50 to 90° C. The polymerization medium may be composed either exclusively of water or of mixtures of water and liquids, such as methanol, which are miscible therewith. It is preferable to use exclusively water. The emulsion polymerization may be carried out either as a batch process or as a feed process, and this includes stepped or gradient procedures. Preference is given to the feed process in which a portion of the polymerization mixture forms an initial charge, is heated to the polymerization temperature and begins to polymerize, and the remainder of the polymerization mixture is then fed into the polymerization zone, usually via two or more spatially separate feed streams, of which one or more comprise(s) the monomers in pure or in emulsified form, these feed streams being supplied either continuously, or in stages, or under a concentration gradient, during which the polymerization is maintained. A seed polymer may also be included in the initial polymerization charge in order, for example, to achieve better regulation of particle size.

In order to bind and remove residual monomers, it may be appropriate to add initiator after the end of the emulsion polymerization and all its stages, i.e., after a monomer conversion of at least 95%, particularly 98%.

The above details apply to the copolymer as a whole.

The copolymer used in accordance with the invention is obtainable by multistage polymerizations, and so the remarks below apply additionally.

It is possible first of all to prepare an aqueous polymer dispersion in conventional manner by emulsion polymerization (referred to for short as 1st stage).

Before commencing the polymerization of further stages (collectively called 2nd stage) it is preferable for all of the monomers of the aqueous dispersion that are to be polymerized in the 1st stage to have been added and to have undergone polymerization to the extent of at least 80% by weight, in particular at least 90% by weight, and very preferably at least 95% by weight.

Before monomers of the 2nd stage are added the polymer dispersion obtained in the first stage is preferably held at elevated temperature, preferably at a temperature of between 60 and 100° C., for at least 5 minutes, more preferably at least 10 minutes.

To polymerize the monomers of the 1st stage it is preferred to add an initiator in amounts of around 0.05 to 5 parts by weight, more preferably from 0.1 to 2 parts by weight, very preferably from 0.1 to 1 part by weight per 100 parts by weight of the monomers to be polymerized in the 1st stage. The initiator can be included in the initial charge or added during the polymerization of the 1st stage.

In the course of the polymerization of the monomers of the 2nd stage less initiator as compared with the 1st stage is used, based on the monomers of the 2nd stage.

The relative amount of initiator, i.e., the amount of initiator in parts by weight per 100 parts by weight of monomer mixture of the 1st stage and of the 2nd stage respectively, is in the 2nd stage less than half, more preferably less than a quarter, of that of the 1st stage.

With very particular preference no initiator at all is added in the 2nd stage.

The monomer mixtures of the 1st and 2nd stages are preferably different in their glass transition temperature (T_{g}).

The glass transition temperature here is the T_{g} of the monomer mixtures as calculated in accordance with the Fox equation (T. G. Fox, Bull. Am Phys. Soc. (Ser. II) 1, 123 (1956)).

The calculation is made from the Tg values of the homopolymers of the monomers, which are listed in the Polymer Handbook, J. Brandrup, E. Immergut, John Wiley & Sons, New York.

The Tg of the monomer mixtures of the two stages differs preferably by at least 10° C., more preferably by at least 20° C., very preferably by at least 30° C., and in particular by at least 50° C.

The monomer mixture of the 2nd stage preferably has the higher Tg.

With preference the monomer mixture of the 2nd stage is composed of at least 50% by weight, more preferably at least 75% by weight, and very preferably from 2 to 100% by weight of methyl methacrylate.

The fraction of the monomer mixture of the 1st stage as a proportion of the whole copolymer is preferably
from 70 to 99.5% by weight, in particular from 80 to 98% by weight, and very preferably from 90 to 98% by weight.

Accordingly, the fraction of the monomer mixture of the 2nd stage is from 30 to 0.5% by weight, from 20 to 2% by weight or from 10 to 2% by weight.

In one very particular embodiment the copolymer is composed of from 93 to 97% by weight of the monomer mixture of the 1st stage and from 7 to 3% by weight of the monomer mixture of the 2nd stage.

The composition is used in accordance with the invention as a laminating adhesive, i.e., for adhesively bonding substrates of large surface area.

For this purpose the composition may be composed exclusively of the aqueous dispersion of the copolymer. It may comprise further additives, examples being wetting agents, thickeners, protective colloids, light stabilizers, biocides, tackifiers, and plasticizers.

Preferably it includes at least one crosslinker for the crosslinkable groups of the copolymer, in particular the keto or aldehyde groups.

The crosslinker is preferably a compound containing at least 2 functional groups, in particular from 2 to 5 functional groups, with particular preference 2 or 3 functional groups, with very particular preference 2 functional groups, which undergo a crosslinking reaction with the copolymer's functional groups, especially the keto or aldehyde groups.

Examples of suitable functional groups for crosslinking the keto or aldehyde groups include hydrazide, hydroxylamine or oxime ether or amino groups.

Suitable compounds containing hydrazide groups are, for example, polycarboxylic hydrazides having a molar weight of up to 500 g/mol.

Particularly preferred hydrazide compounds are dicarboxylic dihydrazides containing preferably from 2 to 10 carbon atoms.

Examples that may be mentioned include oxalic dihydrazide, malonic dihydrazide, succinic dihydrazide, glutaric dihydrazide, adipic dihydrazide, sebacic dihydrazide, maleic dihydrazide, fumaric dihydrazide, itaconic dihydrazide and/or isophthalic dihydrazide. Of particular interest are the following: adipic dihydrazide, sebacic dihydrazide, and isophthalic dihydrazide.

Suitable compounds containing hydroxylamine groups or oxime ether groups are specified, for example, in WO 93/25588.

The compounds preferably comprise hydroxylamine derivatives of the formula
(H₂N—O)—₂A I,
where A is a saturated or unsaturated aliphatic, linear or branched hydrocarbon radical of 2 to 12 carbon atoms, which may be interrupted by from 1 to 3 nonadjacent oxygen atoms, and n is 2, 3 or 4,
or an oxime ether of the formula 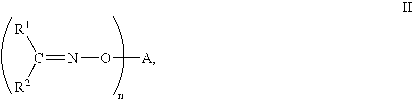
where A and n are as defined above and R¹ and R² independently of one another are C₁-C₁₀ alkyl, C₁-C₁₀ alkoxy, C₅-C₁₀ cycloalkyl or C₅-C₁₀ aryl, which may also contain from 1 to 3 nonadjacent nitrogen, oxygen or sulfur atoms in the carbon chain or in the carbon ring and may be substituted by from 1 to 3 C₁-C₄ alkyl or alkoxy groups; R¹ or R² may be a hydrogen atom,
or R¹ and R² together form a bridge of from 2 to 14 carbon atoms, it also being possible for some of the carbon atoms to be part of an aromatic ring system.

The variables A in formulae I and II preferably comprise a hydrocarbon chain of from 2 to 8 carbon atoms and n is preferably 2.

The radicals R¹ and R² are each preferably a hydrogen atom, a C₁-C₆ alkyl group or a C₁-C₆ alkoxy group. In the case of the hydrogen atom, only one of the radicals, R¹ or R², may be a hydrogen atom.

Examples of suitable compounds containing amino groups include ethylenediamine, propylenediamine, tetramethylenediamine, pentamethylenediamine, hexamethylenediamine, diethylenetriamine, triethylenetetramine, polyethyleneimines, partially hydrolyzed polyvinylformamides, ethylene oxide and propylene oxide adducts such as the Texaco Jeffamines, cyclohexanediamine, and xylylenediamine.

The compound containing these functional groups may be added to the composition, or to the dispersion of the copolymer, at any point in time. In the aqueous dispersion, there is still no crosslinking with the keto or aldehyde groups. Only on drying does crosslinking take place on the coated substrate.

The amount of the compound containing the functional groups is preferably such that the molar ratio of the functional groups to the functional groups, especially keto and/or aldehyde groups of the copolymer is from 1:10 to 10:1, in particular from 1:5 to 5:1, with particular preference from 1:2 to 2:1, and with very particular preference from 1:1.3 to 1.3:1.

In particular, equimolar amounts of the functional groups of the crosslinkers and those of the copolymer, in particular of the keto and/or aldehyde groups, are preferred.

Examples of suitable substrates for adhesive bonding are polymer films, in particular made from polyethylene or oriented polypropylene, polyamide, polyethylene terephthalate, cellulose acetate, cellophane, metalized (e.g., aluminum-coated (vapor-coated)) polymer film (abbreviated to metalized films) or else paper, card or metal foils, in particular made from aluminum. The films and foils mentioned may also have been printed, e.g., with printing inks.

The laminating adhesive is applied to at least one large-surface-area substrate, preferably at a layer thickness of from 0.1 to 20 g/m², particularly preferably from 2 to 15 g/m², e.g., by knife coating, brushing, etc.

Preferably after drying or air-drying to remove the water in the dispersion (e.g., after from 1 to 60 seconds), the coated substrate may then be laminated to a second substrate at a temperature of for example from 20 to 200° C., preferably from 20 to 70° C., and at a pressure of, for example, from 1 to 30 N/m², preferably from 3 to 20 N/m².

In the case of copolymers which are crosslinked photochemically the crosslinking reaction is initiated before or after the lamination, in particular by exposure to high-energy light.

The substrate coated with the adhesive preferably comprises a transparent polymer film.

The polymer or, respectively, the dispersion is preferably used as an adhesive for high gloss film lamination.

In high gloss film lamination, paper or card is adhesively bonded to transparent polymer films. The papers or cards may have been printed.

The novel laminating adhesive gives substrate assemblies with high bond strength, even in the region of grooves or embossments, and with high transparency and high gloss. The high strengths are achieved even with small amounts of crosslinker; in polymers not in accordance with the invention the crosslinker quantities required in order to achieve identical properties are much higher.

### EXAMPLES

A) Preparation

The preparation of the aqueous dispersions followed the following general specification: the initial charge (180 g of water and 3.5 g of styrene seed, 33% concentration) was heated to an internal temperature of 90° C. and 10% of feed 2 was included in the initial charge. Feed 2 was composed of 67 g of sodium peroxodisulfate (2.5% strength). After 5 minutes feed 1, which contains the monomers, and feed 2 were commenced. The composition of feed 1 is indicated in table 1. Feeds 1 and 2 were metered in over 2 h followed by postpolymerization for 0.5 h.

| Dispersion | Monomer composition of feed 1 | | | | |
|---|---|---|---|---|---|
| No. | BA | MMA | AA | DAAM | 2nd stage |
| 1 | 77 | 15 | 2 | 1 | 5 MMA |
| 2 | 77 | 20 | 2 | 1 | — |
| 3 | 76.5 | 15 | 2 | 1.5 | — |
| 4 | 76 | 15 | 2 | 2 | — |

BA: butyl acrylate
MMA: methyl methacrylate
AA: acrylic acid
DAAM: diacetoneacrylamide

The amount of initiator (sodium peroxodisulfate) was in each case 0.3 part by weight, the emulsifier used comprising 0.5 part by weight of Dowfax 2A1 and 0.5 part by weight of Disponil FES77, based on the parts by weight of monomers indicated in the table.

For dispersion 1, the dispersion was left to polymerize for 15 minutes at a temperature maintained at 90° C. The dispersion of the polymer was admixed all at once with 5 parts by weight, based on the total amount of monomers polymerized. Thereafter the dispersion was stirred at 90° C. for 3 minutes.

All of the dispersions, after they had cooled, had added to them an aqueous solution of ADDH (ADDH: adipic dihydrazide; parts by weight of ADDH, solid, indicated in table 1).

B) Mechanical Properties of the Polymer Film

To determine the mechanical properties of the film of the aqueous polymer dispersion it was diluted to a solids content of 25% by weight. A sample of the aqueous polymer dispersion thus diluted was then dried for a few days at room temperature in a silicone mold.

The amount of polymer was made such that the resulting film thickness was approximately 1 mm. The tensile tests were conducted in accordance with the standard ISO 37. The measurements indicated are average values of 6 measurements on 6 test specimens. For that purpose, the test specimens required for the tensile test to be conducted (sample length: 25 mm) were punched from the film after it had been detached from the silicone mold.

The specimens were clamped into the jaws of a tensile testing machine and torn at a take-off rate of 100 mm/min (initial force: 0.05 N and clamped length: 25 mm). The elongation at break is the elongation at the moment of tearing. It relates to 23° C. and 1 atm. It is indicated in the form (L−Lo)/Lo)×100(%), where:
Lo=the original measurement length
L=the measurement length on tearing

The mechanical properties determined on the associated polymer film were as follows:

TABLE 1

| | DAAM/ADDH | Strain (MPa) | Elongation (%) |
|---|---|---|---|
| No. | (pphm) | Average | Average |
| 1 | 1/0.5 | 1.62 ± 0.26 | 477.6 ± 43 |
| 2 | 1/0.5 | 0.96 ± 0.10 | 410.3 ± 28.8 |
| 3 | 1.5/0.75 | 1.1 ± 0.11 | 379.4 ± 19.9 |
| 4 | 2/1 | 1.39 ± 0.16 | 338.3 ± 27.1 |

Dispersion 1 shows the highest strain and elongation values.

C) High Gloss Film Lamination
Substrates:
   chromoduplex 2 card, printed
   chromolux 700 card, printed
   polypropylene film, electrically pretreated on one side (PP)

The adhesive under test is coated using a barcoater directly onto the PP film (amount of adhesive applied=8-10 g dry/m²). The adhesive is dried using a cold air fan and then the printed card is pressed on the roller laminating station at 70° C.

Embossing—this is the mechanical deformation of the surface of the laminated substrates by means of a patterned roller on the film side.

Prior to embossing, the laminate is stored at room temperature for at least 24 hours. For the test, the laminates are embossed on the film side in a roll mill with an embossing roller. After preselected storage times, the embossments are tested for detachment of the laminating film from the card, and assessed (see gradings for table 4).

Grooving—this is the mechanical deformation (grooves) of high gloss film laminations.

The laminate is stored at room temperature for at least 24 hours prior to grooving. For the test, the laminates are grooved in a lever press. After preselected storage times, the grooves are tested for detachment of the laminating film from the card, and assessed (see gradings under table 3).

The adhesion is tested by removing the film from the card at an angle of about 180 degrees, and assessed (see gradings under table 2).

TABLE 2
Assessment of the adhesion

Dispersion

| | 1 | 2 | 3 | 4 |
|---|---|---|---|---|
| Chromolux 700 | | | | |
| Adhesion after | | | | |
| Immediately | 1-2 | 1-2 | 1-2 | 1-2 |
| 24 h | 1 | 1 | 1 | 1 |
| 1 week | 1 | 1 | 1 | 1 |
| 6 weeks | 1 | 1 | 1 | 1 |
| Chromoduplex | | | | |
| Adhesion after | | | | |
| Immediately | 3-4 | 3-4 | 4 | 4 |
| 24 h | 1-2 | 1-2 | 1-2 | 1-2 |
| 1 week | 1-2 | 1-2 | 1-2 | 1-2 |
| 6 weeks | 1-2 | 1-2 | 1-2 | 1-2 |

Grading:
1 = complete paper or fiber tearout
2 = partial paper or fiber tearout
3 = good adhesion with adhesive fracture of card or film
4 = poor adhesion
5 = no adhesion to card or film

TABLE 3
Assessment of the grooving

Dispersion

| | 1 | 2 | 3 | 4 |
|---|---|---|---|---|
| Chromolux 700 | | | | |
| Grooving after | | | | |
| 24 h | 1-2 | 1 | 1- | 2 |
| 1 week | 1-2 | 1 | 1- | 2 |
| 6 weeks | 1-2 | 1 | 1- | 2-3 |
| Chromoduplex | | | | |
| Grooving after | | | | |
| 24 h | 1-2 | 1 | 1-2 | 3 |
| 1 week | 2 | 2-3 | 2 | 3-4 |
| 6 weeks | 2 | 3 | 3 | 4 |

Grading:
1 groove is fully satisfactory
2 groove is open slightly at particular points
3 groove is open significantly at particular points
4 groove is completely open

TABLE 4
Assessment of the embossing

Dispersion

| | 1 | 2 | 3 | 4 |
|---|---|---|---|---|
| Chromolux 700 | | | | |
| Embossing after | | | | |
| 24 h | 1-2 | 2-3 | 2-3 | 3 |
| 1 week | 1-2 | 2-3 | 2-3 | 3 |
| 6 weeks | 2 | 3 | 3 | 3-4 |
| Chromoduplex | | | | |
| Embossing after | | | | |
| 24 h | 1-2 | 2-3 | 1-2 | 2 |
| 1 week | 1-2 | 2-3 | 1-2 | 2 |
| 6 weeks | 2 | 2-3 | 2 | 2 |

Grading:
1 = indentations opened at 0 to <10%
2 = indentations opened: >= 10 to <= 40%
3 = indentations opened: >= 40 to <= 60%
4 = indentations opened: >60 to <= 90%
5 = indentations opened: >90 to 100%.

1-10. (canceled)

11. A method of making a laminate, comprising:
coating a film with an adhesive, comprising an adhesive copolymer, obtained by multistage free radical polymerization comprising:
(1) preparing an aqueous polymer dispersion to form a copolymer; and
(2) adding and polymerizing additional monomers with the copolymer of (1) to form said adhesive copolymer;
contacting the adhesive coated portion of said film with a substrate thereby making a laminate.

12. The method of claim 11, wherein the glass transition temperature of the copolymer in (1) and the glass transition temperature of a polymer polymerized from the monomers in (2) differ by at least 10° C.

13. The method of claim 11, wherein the glass transition temperature of the copolymer in (1) is from −60° C. to +30° C.

14. The method of claim 11, wherein the adhesive copolymer in (2) comprises at least 40% by weight of a monomer selected from the group consisting of a C¹ to C²⁰ alkyl(meth)acrylate, a vinyl ester of a carboxylic acid containing up to 20 carbon atoms, a vinyl aromatic having up to 20 carbon atoms, a ethylenically unsaturated nitrile, a vinyl halide, a vinyl ether of alcohols containing from 1 to 10 carbon atoms, an aliphatic hydrocarbon having from 2 to 8 carbon atoms and one or two double bonds, and mixtures thereof.

15. The method of claim 11, wherein the adhesive copolymer comprises from 0.0001 to 1 mole of a ketone, an aldehyde, or mixtures thereof per 100 g of copolymer.

16. The method of claim 15, wherein the adhesive copolymer further comprises a compound which undergoes crosslinking with said ketone, aldehyde, or mixtures thereof.

17. The method of claim 11, wherein the adhesive copolymer comprises at least 80% by weight of the polymer dispersion of (1).

18. The method of claim 11, wherein (2) is conducted after at least 90% of the monomers in (1) have undergone polymerization.

19. The method of claim 11, wherein the polymerization of the adhesive polymer is conducted in the presence of a polymerization initiator.

20. The method of claim 19, wherein the polymerization of the adhesive copolymer comprises not more than 0.05 parts by weight of initiator per 100 parts by weight of the monomers added in (2).

21. The method of claim 11, further comprising drying the adhesive prior to said contacting.

22. The method of claim 11, further comprising heating, and applying pressure to, the laminate after said contacting.

23. The method of claim 22, wherein the laminate is heated to a temperature from 20° C. to 200° C.

24. The method of claim 22, wherein the laminate is pressurized to a pressure from 1 N/m³ to 30 N/m³.

25. The method of claim 11, further comprising applying a high energy light before, after, or before and after said contacting.

26. The method of claim 11, wherein said substrate is a printed card.

27. The method of claim 11, wherein said substrate is a piece of paper.

28. The method of claim 11, wherein said substrate is a transparent polymer film.

29. A laminate obtained by the method of claim 11.
